(19) United States
(12) Patent Application Publication
(10) Pub. No.: US 2022/0237725 A1
(43) Pub. Date: Jul. 28, 2022

(54) SYSTEMS AND METHODS FOR OPTIMIZING DATA SHARING IN RELATION TO A PLURALITY OF ADMISSION APPLICATIONS

(71) Applicant: OCAS, Guelph (CA)

(72) Inventors: Michael Aldworth, Guelph (CA); Sukhpreet Kaur Bedi, Waterloo (CA); Dennis Neil Giesbrecht, Guelph (CA); Wayne Edward Jason Hesch, Waterloo (CA); Eliza Jeyakumar, Waterloo (CA); Oana Lopez Rodriguez, Guelph (CA); Saheem Shahabuddin Mukaddam, Kitchener (CA); Nipun Sharma, Waterloo (CA); Jaime Andres Valencia Salazar, Kitchener (CA); Michael Arman Williamson, Guelph (CA)

(21) Appl. No.: 17/657,371

(22) Filed: Mar. 31, 2022

Related U.S. Application Data
(63) Continuation-in-part of application No. 17/445,015, filed on Aug. 13, 2021.
Application No. 17/445,015 is a continuation of application No. 16/286,720, filed on Feb. 27, 2019.
Application No. 16/286,720 is a continuation of application No. 16/286,676, filed on Feb. 27, 2019.
(60) Provisional application No. 62/813,703, filed on Mar. 4, 2019.

(51) Int. Cl. G06Q 50/20; G06Q 20/02; H04L 67/306; G06Q 30/02

(52) U.S. Cl. CPC G06Q 50/2053; G06Q 30/0282; H04L 67/306; G06Q 20/02

(57) ABSTRACT

Systems and methods for optimizing data sharing in relation to a plurality of admission applications, the system involving a ranking subsystem and a routing subsystem. The ranking subsystem has a ranking subsystem application program interface front end configured to communicate with at least one of a service bus and a database, publish an event from at least one of an admission applicant update and an admission application submission, and facilitate completion of an admission application. The routing subsystem has a routing subsystem application program interface front end, the routing subsystem application program interface front end configured to communicate with the database and transmit at least one of event information and configuration information to the database.

### CROSS-REFERENCE TO RELATED APPLICATION(S)

This document is a continuation-in-part application claiming the benefit of, and priority to, U.S. patent application Ser. No. 17/445,015, entitled “SYSTEM AND METHOD OF APPRENTICESHIP PROGRAM MANAGEMENT,” filed on Aug. 13, 2021; and U.S. patent application Ser. No. 16/286,720, entitled “SYSTEM AND METHOD FOR MULTI-INSTITUTIONAL OPTIMIZATION FOR A CANDIDATE APPLICATION SYSTEM,” filed on Feb. 27, 2019; International Patent Application No. PCT/CA2020/050262, entitled “SYSTEM AND METHOD OF APPRENTICESHIP PROGRAM MANAGEMENT,” filed on Feb. 27, 2020; U.S. patent application Ser. No. 16/286,676, entitled “SYSTEM AND METHOD FOR ACHIEVING CANDIDATE DIVERSITY IN A ADMISSION APPLICATION SYSTEM,” filed on Feb. 27, 2019; and U.S. Provisional Patent Application Ser. No. 62/813,703, entitled “SYSTEM AND METHOD OF APPRENTICESHIP PROGRAM MANAGEMENT,” filed on Mar. 4, 2019, all of which are incorporated herein by reference in their entirety.

### FIELD

Generally, the present disclosure relates to institutional admission application systems and methods. More particularly, the present disclosure relates to systems and methods for multi-institutional optimization of the institutional admission application system for supporting post-secondary education institutions.

### BACKGROUND

In a post-secondary institution application system soliciting institutional admission applications from internationally-located admission applicants, an agency model is often employed, to ease the admission application process. In this model, agencies local to institutional admission applicants work directly with institutions or application centers and submit applications on behalf of the institutional admission applicants.

In a multi-institutional admission application system, where institutions compete for both institutional admission applicants and funding, and also co-operate in their offerings of programs, having a centralized system for receiving institutional admission applications, receiving data from institutions, as well as aggregating and analyzing this data is beneficial for institutions and the overall multi-institutional application system. As the institutions both compete and co-operate, some data needs to be independently held and made available to other institutions only as aggregated or otherwise anonymized data. This data sharing allows better cooperation among the institutions in dealing with agencies and allows better targeting of institutional admission applicants for programs in a way that reduces agency fee payouts overall, improves agency quality through fee incentives for better agency performance, and improves applicant success and maximizes enrollment by ensuring applicants are placed in best-suited programs and institutions.

Colleges receive a high volume of admission applications from many admission applicants from many countries, wherein higher numbers of admission applications are received from certain countries. In the related art, educational institutions face challenges in maximizing enrollment and in identifying the most qualified applicants. Currently, maximizing enrollment and identifying the most qualified applicants are manually performed by college admission staff who look at factors, such as the admission applicant's academic grade averages and various credentials. Then, the college admission staff manually rank those admission applicants from highest to lowest, based on the programs to which they are applying. This process is time-consuming. Therefore, a need exists for systems and methods that optimize a multi-institutional admission application system for reducing costs, improving enrollment, and streamlining the admissions process so that the college admission staff can focus its attention on those admission applicants with the highest probability of success.

### SUMMARY

To address at least the related art challenges, in accordance with embodiments of the present disclosure, systems and methods that use semi-blind data-viewing in a semi-cooperative context, when appropriate, for optimizing data-sharing in a multi-institutional admission application system are provided. Methods are provided for evaluating agency quality and individual student success probability as well as for sharing these evaluations among a plurality of institutional admission applicants, e.g., wherein each institutional candidate is applying to a plurality of academic programs, e.g., international academic programs or a plurality of institutions that are located in a plurality of countries, while retaining the confidentiality of each institutional admission applicant, in accordance with some embodiments of the present disclosure. Multiple parameters, both immediate and historic, are used to evaluate agency quality and individual student success probability. The systems and methods of the present disclosure optimize a multi-institutional admission application system, thereby reducing costs and improving enrollment. Other features and advantages of the optimization systems and optimization methods of the present disclosure are more fully below described.

Generally, the optimization systems and optimization methods of the present disclosure provide a solution to many of the related art challenges by ranking a plurality of multi-institutional admission applications based on each multi-institutional admission applicant's performance in relation to specified criteria, thereby providing a ranking of the plurality of multi-institutional admission applications. Ranking the plurality of multi-institutional admission applications comprises applying a ranking formula. The specified criteria comprise at least one of: language proficiency test scores, e.g., English proficiency test scores, grade averages, skills assessment through testing administered by the colleges, eligibility for Student Direct Stream (SDS) study permit processing, a likelihood of successfully attaining the SDS study permit, and a likelihood of obtaining a student visa.

Further, the optimization systems and optimization methods of the present disclosure provide tools for using new data points, corresponding to the ranking, that facilitates managing, sorting, and filtering the plurality of multi-institutional admission applications by an international entrance (IE) team, thereby more effectively and more efficiently processing the plurality of multi-institutional admission applications than otherwise would be processed by related art multi-institutional admission application systems. The optimization systems and optimization methods of the present disclosure also provide solutions to the related art challenges by ranking admission applications based on calculated academic averages (e.g., taking a higher credential average of a plurality of credential averages), capturing a raw grade average from each admission application, such as during an admission application process (e.g., during an online fillable admission application process), thereby providing further tools that allow the IE team to manage, sort, and filter the plurality of admission applications based on these new data points, and thereby more effectively and efficiently processing the plurality of admission applications than possible in the related art.

In an embodiment of the present disclosure, an admission application system, having a processor configurable by a set of executable instructions storable in relation to a non-transient memory device, for optimizing data sharing in relation to a plurality of admission applications, comprises: a ranking subsystem, the ranking subsystem comprising a ranking subsystem application program interface front end, the ranking subsystem application program interface front end configured to communicate with at least one of a service bus and a database, publish an event from at least one of an admission applicant update and an admission application submission, and facilitate completion of an admission application; and a routing subsystem, the routing subsystem comprising a routing subsystem application program interface front end, the routing subsystem application program interface front end configured to communicate with the database and transmit at least one of event information and configuration information to the database.

In an embodiment of the present disclosure, a method of providing an admission application system, having a processor configurable by a set of executable instructions storable in relation to a non-transient memory device, for optimizing data sharing in relation to a plurality of admission applications, comprises: providing a ranking subsystem, providing the ranking subsystem comprising providing a ranking subsystem application program interface front end, providing the ranking subsystem application program interface front end comprising configuring the ranking subsystem application program interface front end to communicate with at least one of a service bus and a database, publish an event from at least one of an admission applicant update and an admission application submission, and facilitate completion of an admission application; and providing a routing subsystem, providing the routing subsystem comprising providing a routing subsystem application program interface front end, providing the routing subsystem application program interface front end comprising configuring the routing subsystem application program interface front end to communicate with the database and transmit at least one of event information and configuration information to the database.

In an embodiment of the present disclosure, a method of optimizing data sharing in relation to a plurality of admission applications by way of an admission application system, having a processor configurable by a set of executable instructions storable in relation to a non-transient memory device, the comprises: providing the admission application system, providing the admission application system comprising: providing a ranking subsystem, providing the ranking subsystem comprising providing a ranking subsystem application program interface front end, providing the ranking subsystem application program interface front end comprising configuring the ranking subsystem application program interface front end to communicate with at least one of a service bus and a database, publish an event from at least one of an admission applicant update and an admission application submission, and facilitate completion of an admission application; and providing a routing subsystem, providing the routing subsystem comprising providing a routing subsystem application program interface front end, providing the routing subsystem application program interface front end comprising configuring the routing subsystem application program interface front end to communicate with the database and transmit at least one of event information and configuration information to the database; and operating the admission application system.

Some of the features in the present disclosure are broadly outlined in order that the section entitled Detailed Description is better understood and that the present contribution to the art is better appreciated. Additional features of the present disclosure are described hereinafter. In this respect, the present disclosure is not limited in its implementation to the details of the components or steps, as herein set forth or as illustrated in the several figures of the Drawing, but may be carried out in various ways that are also encompassed by the present disclosure. The phraseology and terminology herein employed are for the purpose of the description and should not be regarded as limiting.

### BRIEF DESCRIPTION OF THE DRAWINGS

The above, and other, aspects, features, and advantages of several embodiments of the present disclosure will be more apparent from the following Detailed Description as presented in conjunction with the several figures of the Drawing which are described as follows.

FIG. 1 is a diagram illustrating a multi-institutional admission application system, in accordance with an embodiment of the present disclosure.

FIG. 2 is diagram further illustrating components of a multi-institutional admission application system, in accordance with an embodiment of the present disclosure.

FIG. 3 is a flow diagram illustrating a method of optimizing data sharing by way of a multi-institutional admission application system, in accordance with an embodiment of the present disclosure.

FIG. 4 is a flow chart illustrating a method of optimizing data sharing by way of a multi-institutional admission application system, in accordance with an alternative embodiment of the present disclosure.

FIG. 5 is a diagram illustrating workflow in an implementation of a multi-institutional admission application system, comprising a ranking subsystem, for optimizing data sharing by a plurality of institutions in relation to a plurality of multi-institutional admission applications, in accordance with an embodiment of the present disclosure, in accordance with an embodiment of the present disclosure.

FIG. 6 is a diagram illustrating workflow in an implementation of a multi-institutional admission application system, comprising a routing subsystem, for optimizing data sharing by a plurality of institutions in relation to a plurality of multi-institutional admission applications, in accordance with an embodiment of the present disclosure.

FIG. 7 is a table illustrating examples of declared school types, possible declared credential type, and a mapped credential type to a multi-institutional admission application system or international application system (IAS) categories as by the ranking subsystem, in accordance with an embodiment of the present disclosure.

FIG. 8 is a table illustrating examples of multi-institutional admission application system or IAS credential types for the program selection, program categories, and logic as used by the ranking subsystem, in accordance with an embodiment of the present disclosure.

FIG. 9 is a table illustrating example parameters for screening by the ranking subsystem for post-secondary school degree program, in accordance with an embodiment of the present disclosure.

FIG. 10 is a table illustrating example parameters for screening by the ranking subsystem for project management program, in accordance with an embodiment of the present disclosure.

FIG. 11 is a table illustrating example parameters for screening by the ranking subsystem 500 for a fast-track program, in accordance with an embodiment of the present disclosure.

FIG. 12 is a flow diagram illustrating a method of providing an admission application system, having a processor configurable by a set of executable instructions storable in relation to a non-transient memory device, for optimizing data sharing in relation to a plurality of admission applications.

FIG. 13 is a flow diagram illustrating a method of optimizing data sharing in relation to a plurality of admission applications by way of an admission application system, having a processor configurable by a set of executable instructions storable in relation to a non-transient memory device, in accordance with an embodiment of the present disclosure.

Corresponding reference numerals or characters indicate corresponding components throughout the several figures of the Drawing. Elements in the several figures of the Drawing are illustrated for simplicity and clarity and have not necessarily been drawn to scale. For example, the dimensions of some elements in the several figures may be emphasized relative to other elements for facilitating understanding of the various presently disclosed embodiments. Also, common, but well-understood, elements that are useful or necessary in commercially feasible embodiment are often not depicted to facilitate a less obstructed view of these various embodiments of the present disclosure.

### DETAILED DESCRIPTION

In general, an optimization system comprises: a student application subsystem having an agency interface, an administrative interface, and an institutional interface; a subsystem for receiving a plurality of student applications from a plurality of agencies; a subsystem for receiving and storing statistics and feedback from a plurality of institutions; and a subsystem for storing and correlating application information and institutional information, in accordance with some embodiments of the present disclosure. The word “institution” or the phrase “educational institution” refers to any institute of higher education, including, but not limited to, a vocational college, a public college, a private college, a public university, a private university, or a trade school. The phrase “post-secondary” refers to further education above and beyond secondary school and or high school. The embodiments of the present disclosure are with any institution's admission application system, including, but not limited to, non-post-secondary educational institution application systems. An optimization system comprises other subsystems as well which are below described in detail.

### Subsystem for Evaluating and Handling Agency Quality

A subsystem for evaluating and handling agency quality uses various measures of agency quality that are related to performance of each agency of a plurality of agencies on behalf of at least one of a plurality of applicants and a plurality of institutions. For example, one agency may frequently incorrectly fill application forms, thereby delaying processing an application, thereby requiring resubmission of the admission application, thereby burdening both an admission application center as well as the admission applicant. Another example is an agency recommending that admission applicants apply to many programs for which the admission applicant is not well qualified, wherein, although this approach appears favourable to the admission applicant, the chances of admission are not improved; and the admission application system is burdened additional admission applications. Therefore, identifying and incenting factors which improve admission application quality from agencies are benefits provided by the systems and methods of the present disclosure, whereby the admission application system becomes less burdened, and whereby certainty is improved and cost is reduced for admission applicants.

The present disclosure makes use of, and extends, an existing student success tracking system to create appropriate incentives for agents, by correlating various measures of student success with their initiating agency. The present disclosure comprises a computer system which implements a storage mechanism for data, a computational mechanism for scoring and at least one user interface.

Embodiments of the present disclosure use at least one measure of agency quality, including, but not limited to the following metrics: historical applicant success rate for applicants from this agency, or a measure of number or percentage of successful applications which reach a given stage of the admission application pipeline, from initial application to acceptance by a post-secondary institution to enrollment to completion of the first semester to graduation from the program to finding employment in a relevant industry; and historical application-program continuity rate for admission applicants from this agency, historical application-program continuity rate denoting a percentage of accepted students from a given agency that do not switch programs of study upon beginning their studies, wherein scoring low on this metric may indicate that an agency is deliberately encouraging lower quality admission applicants to apply to programs with lower admission standards which may be unrelated to the admission applicant's desired program and with the intention of the admission applicant switching into the desired program once the course of study begins; admission applicant English proficiency scores; total number of admission applicants, wherein this metric is positively correlated with agency quality in the view of institutions which charge per admission application; but this metric is negatively correlated in the view of institutions which do not, and which, therefore, have more applications to process; admission application formal quality, which may itself be measured through incidence of transcript or English score fraud, through admission application completeness or the incidence of an institution needing to request supplementary materials which should have been included with the admission application, through incidence of application errors, or through any other measure or measures of application formal quality; agency satisfaction ratings provided by applicants to an institution, to a third-party rating agency, or to any other organization which may wish to evaluate applicant satisfaction with an agency; an agency's certification or lack thereof, which certification may be a government certification; and any other metric by which the performance of an agency may be measured.

An implementation may calculate these metrics per agency and store them centrally. The aggregate metrics (measured per applicant) may be averaged or weight-averaged across all or some admission applicants who made use of that agency. The summed metrics (measured in total) may be tallied per agency. The inverse or complement of one or more metrics may be used, where a higher score is less desirable. Weightings may be applied per metric. An agency score may then be calculated; one method would be to simply sum the weighted values of the metrics.

Any subset of the metrics used may be in turn used to calculate a subscore; this may be useful if, for example, one of the metrics is not deemed important for a particular scoring purpose, or if there is some question about what effect a particular metric may be having on a score. A subset comprising at least a single metric may also be used to create a subscore. The underlying data for the agency metrics may be directly input via the institutional user interface, may be entered through an admission application processing system, may be automatically generated through analysis of how applications are handled and flagged by client institutions, or may be input or imported through some other means.

### Institutional User Interface

Preferably, the system will present a user interface for client institutions. This interface may display metrics of agency quality in a way which allows for comparison of one agency against another, whether by overall score or by subscore. The interface may display a time series of agency score or subscore, per agency. The interface displays an aggregation of agency scores or subscores by geographic region, via commission paid to the agency, or via any other natural or arbitrary grouping of agencies. When displaying these aggregations, the user interface shows one aggregate group's scoring against another groupings' or highlights one or more agencies' scoring as compared to the group to which they belong.

Client institutions may wish to keep confidential the list of agencies with whom they are associated. However, the aggregation of data across multiple institutions may showcase trends or data-points which may not be immediately evident from the data of a single institution. In light of these factors, the system may, for each client institution, preferably automatically aggregate and obfuscate the data from other institutions, while leaving data from the client institution unobfuscated; and this aggregation would be performed automatically depending on the identity of the client institution logged into the system.

### Institutional Feedback

Client institutions understand that all institutions benefit if lower-quality agencies are identified. To this end, the system implements a user interface which allows institutions to comment on, or provide, an institutional score for any given agency. The institutional score for a given institution for any agency is displayable as one of the metrics and is anonymized to prevent identification of the scoring institution. The institutional scores for an agency are weighted together or aggregated to provide an overall institutional score for the agency.

Institutions may place one or more agencies on hold, such as temporarily or permanently stopping accepting applications from those agencies, based on factors, such as low-quality applicants or higher than average incidence of fraud. The institutional feedback user interface allows institutions to indicate that a particular agency has been placed on hold. Institutions may use outcome tracking to determine fees or other compensation paid to agencies. For example, an agency which consistently submits successful applicants may earn higher fees based on a higher agency score.

### Automated Queries

An implementation of the present disclosure involves a system for automated queries of agency score. The queries come from institutions or a student application system and are associated with particular admission applications as those admission applications are received from an agency. This facility is used to weight individual admission applications. The admission application, as a whole, is weighted with a score derived from the metrics of the agency through which the admission application was submitted, or a portion of the admission application is weighted or flagged as a result of a score or subscore of its originating agency. Additionally, specific actions are taken on a specific application, depending on the scoring of its originating agency.

As an example, an admission application is received from an agency which traditionally has a higher than average incidence of English proficiency test score fraud. If English proficiency test score fraud is a metric by which this agency has been scored, this admission application is appropriately scored and is ranked lower than an admission application received from any agency which has an average incidence of such fraud. Alternatively, the admission application is flagged to indicate a potentially higher likelihood of test score fraud in a dedicated field on the admission application as the institution would receive it, e.g., in a human-readable notice in an appropriate location on the admission application or in some other manner.

In another example, an admission application is received from an agency which has traditionally submitted only very high quality applications from high quality admission applicants. The admission application system queries the agency scoring system and receives a very high score for the agency. If the admission application shows outstanding grades for the admission applicant, then, coupled with the high score for the agency, the admission application system automatically generates an offer for the admission applicant, or may flag the admission application in some way as being a high quality admission application.

The admission application system also compares the score of a particular agency with the scores of other agencies to facilitate the ranking of agencies and to automatically detect whether the fees paid to an agency are higher or lower than the fees paid to similarly-ranked agencies. Such a disparity is flagged to an educational institution or to the administrators of the admission application system.

### Centralized Tracking of Applicant Outcomes

In some situations, post-secondary institutions have an interest in or mandate to work co-operatively to optimize student success, as measured by any number of metrics. For example, a college X, located in one area, is attractive to international admission applicants from a certain region, because the local population around college X has a higher than average proportion of immigrants from that region. Another college Y, located in another area, offers a similar program, but in such other area without an immigrant population. If both colleges act independently, student success, as measured by graduation rate, is lower overall than if the colleges were to act in concert to boost student success. For example, some international students from the noted region, attending a college other than college X, may not find the community support they need to succeed and do not graduate, but they would have found success had they attended college X, wherein the selected college then loses the upper-year revenue as this student's seat goes empty. Additionally, if the intake rate at college X does not meet demand, the entire post-secondary network in question may lose some international admission applicants who, not being able to attend college X, may opt for attending school in a different post-secondary network or may not pursue higher education at all, wherein the network then loses the opportunity to educate this admission applicant as well as the concomitant revenue. Considering these circumstances have tremendous ramifications, for example, on increasing public funding of post-secondary education, increasing student success, decreasing jumper rates (proportion of enrolled students not attending any classes) and melt rates (proportion of enrolled students attending fewer than ten days of classes), and decreasing the cost of delivering some programs.

The present disclosure involves a system which centrally tracks student success for a post-secondary institution network and allows for inter-institutional trading of seats, students, or programs. The system comprises a computer system which implements a storage mechanism for data and at least one user interface. Preferably, the system acts in concert with, or as part of, an educational institution admission application system, such that admission applications are stored and relevant data need not be re-entered.

An implementation of the system involves directly connecting to a client institution's student database, such that student success information is transferred directly to this system. An implementation involves presenting a user interface which allows student information to be directly input or may directly-transfer information to be overridden. Such a user interface supplements or replaces the direct connection to the institution's student database.

Preferably, an implementation of the system correlates the student information from the institution's student database to the information from the student's initial admission application, the latter of which comprises information relating to at least one of: a country of origin, an applying agency, an English proficiency score, and educational institution evaluations, such as grades, prior work experience, desired institution, desired program, or any other information which may form part of the admission application process. Information from the institution's student database may include current program, institution, course grades, graduation information, post-graduate employment information, work placement information, or any other information which may form part of a student's file.

The user interface presented to client institutions is configured to calculate or show correlations between any of the information factors present, in a multivariate fashion. For example, the user interface is configured to show what proportion of students from a given region have graduated, per institution, or what proportion of admission applicants from a given region have a higher than average jumper rate, or what proportion of students from a particular agency have found work in their field six months after graduation.

As some institutions may prefer that their data be kept confidential, the client institution user interface selectively aggregates or obfuscates the data from a given institution when viewed by another institution, to prevent identification of data from a specific institution. As some institutions may wish to share data with one another, the user interface selectively aggregates or obfuscates the data only from certain institutions, while leaving the data from other institutions viewable.

The system is configured to process certain metrics across institutions and identify anomalies, such as a higher than average graduation or jumper rate for admission applicants or students from a particular region. This facility allows institutions to ascertain their relative strengths and weaknesses as related to these correlations, and either to make changes within their institutions to address issues, or, if so determined, to limit enrollment from admission applicants whom they are not appropriately equipped to support.

The system is configured to calculate and suggest appropriate seat trades, that is, exchanges of increased enrollment at one institution X for a particular set of admission applicants to a particular program, essentially traded for another institution Y decreasing enrollment for a similar set of admission applicants. Similar exchanges with other institutions within a given post-secondary network may be feasible such that the total number of program spaces (seats) within the network is not changed, but each seat is filled with an admission applicant who is more likely to succeed in their program.

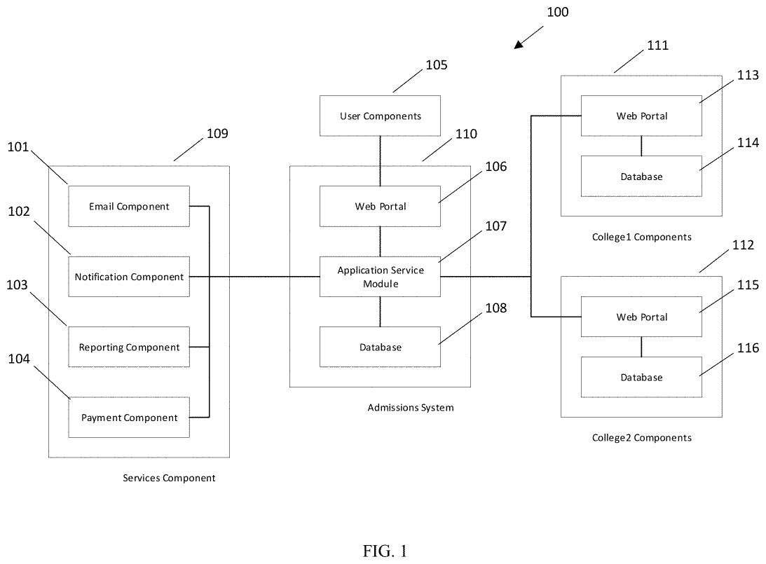

Referring to FIG. 1, this diagram illustrates a multi-institutional admission application system 100, in accordance with an embodiment of the present disclosure. The multi-institutional admission application system 100 comprises four main functional components: a user component 105, e.g., a user computer, a services component 109, an admissions system 110, and college components corresponding to a plurality of higher education institutions, e.g., a first college component 111 and a second college component 112. The user component 105 communicates with the admissions system 110 through the web portal 106. The web portal 106 manages the tasks required to prompt the user for information and to receive this information. The web portal 106 is implemented in one of several technologies, such as a web based application program, a PC application program, or mobile device application program, a terminal application program, or other data entry system.

Still referring to FIG. 1, the information collected in the web portal 106 is stored on the application server module 107. The application server module 107 is also coupled with the database 108 that stores the information input by the users, via the user component 105, in a non-volatile manner. Depending on several factors, such as the information input by the users (not shown) via the user component 105, time, and information from other sources in the admission application system 100, such as the first college component 111 and the second college component 112, the application server module 107 is configured to calculate or determine whether additional actions are required, such as one of the services, via the services component 109. The services, via the services component 109, are represented as functional blocks that can initiate various actions.

Still referring to FIG. 1, the application server module 107 communicates with the email module 101 for initiating an email. The application server module 107 also communicates with a notification module 102 for initiating a notification to other users of the system 100. These notifications comprise notifications, such as at least one of system status changes, the opening and closing of application windows, and notifications of upcoming events.

Still referring to FIG. 1, the application server module 107 communicates with the Payment module 104 when payment events are required. This may include prepayment of application fees, government fees, admission fees, fees held in escrow for assurance of future actions, or other types of fees. The Payment module 104 reports the status of payment activity to the application server module 107 for further processing. The college components, e.g., the first college component 111 and the second college component 112, access the admissions system 110 in a manner similar to the user component 105, but have access to different and additional data.

Still referring to FIG. 1, for example, the first college component 111 has a web portal interface 113 that is coupled with a database 114 that stores local copies of the information from the admissions system 110 in addition to storing information from additional sources within the college. This permits the college to combine information from the admissions system 110 with local college information to create insights that can be used to competitive advantage. Similarly, the second college component 112 has a web portal interface 115 that is coupled with a database 116 that stores local copies of the information from the admissions system 110 in addition to being able to store information from additional sources within the college. This permits the college to combine information from the admissions system 110 with local college information to create insights that can be used to competitive advantage. The information that can be used to create competitive intelligence include number of applicants, location of applicants, academic record of applicants, extra-curricular activities of applicants, spoken language of applicants, and other information. This can be combined with conversion rate, success rate, agency quality, applicant quality, the success of previous applicants with similar profiles, or other measures.

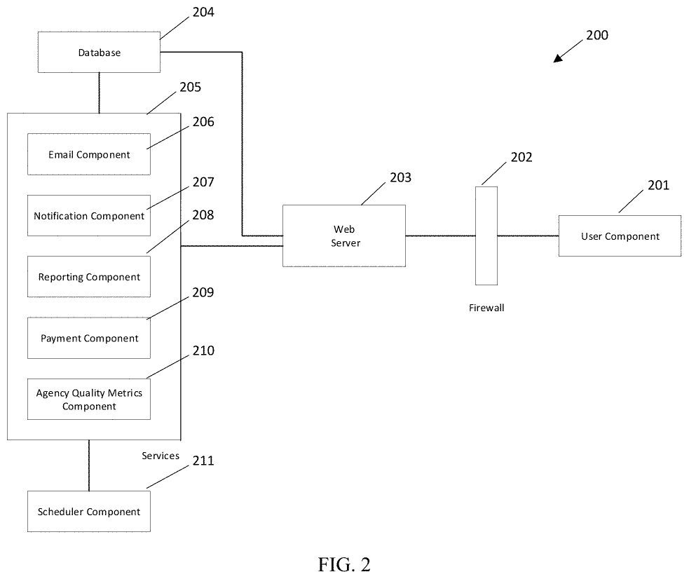

Referring to FIG. 2, this diagram illustrates components, such as hardware and software components of a multi-institutional admission application system 200, in accordance with an embodiment of the present disclosure. The multi-institutional admission application system 200 comprises various modules that enable user interaction. A user (not shown), via a user component 201, e.g., a user computer, communicates through a firewall 202 to a web server 203. The firewall 202 provides protection against unauthorized access and malicious attacks to the multi-institutional admission application system 200.

Still referring to FIG. 2, the web server 203 hosts the user interface that manages the tasks required to prompt the user for information, and to receive this information. The web server 203 is coupled with the database 204, the database 204 configured to store the information that is input by a user via a user component 201, or a plurality of users via respective user components 201, in a non-volatile manner. The web server 203, the database 204, and the scheduler component 211 work in conjunction to initiate activities in the services component 205. The services component 205 is represented as functional blocks that can initiate various actions. The web server 203, the database 204, and the scheduler component 211 communicate with the email component 206 for initiating an email. The web server 203, the database 204, and the scheduler component 211 also communicate with a notification component 207 for initiating a notification to other users of the multi-institutional admission application system 200. These notifications may include notifications such as at least one of system status changes, the opening and closing of application windows, and notifications of upcoming events.

Still referring to FIG. 2, the web server 203, the database 204, and the scheduler component 211 communicate with the payment component 209 when payment events are required. This may include prepayment of application fees, government fees, admission fees, fees held in escrow for assurance of future actions, or other types of fees. The payment component 209 stores the record of payment activity in the database 204. The web server 203, the database 204, and the scheduler component 211 are coupled with the agent quality metrics component 210. The agent quality metrics component 210 module, for example, algorithmically calculates an agent quality metric based on historical admission applicant success rate, historical admission application program continuity rate, admission applicant English proficiency scores, total number of admission applicants, admission application formal quality, agency satisfaction ratings, agency's certification, or other metrics. These windows may be recorded in the database 204, and used to modify the available options on the web server 203.

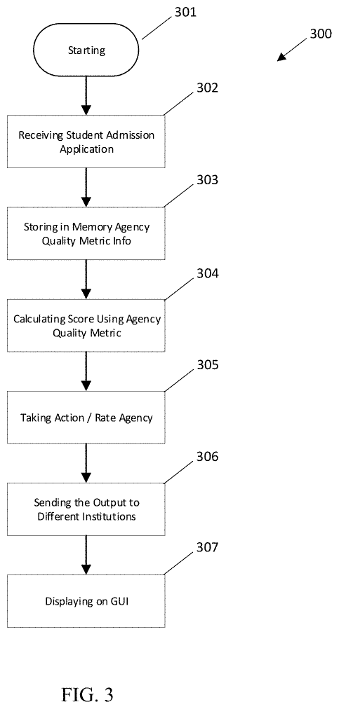

Referring to FIG. 3, this flow diagram illustrates a method 300 of optimizing data sharing by way of a multi-institutional admission application system, e.g., the systems, 100, 200, in accordance with an embodiment of the present disclosure. The method 300 comprises: starting at step 301, e.g., by initiating operation of the multi-institutional admission application system, e.g., the systems, 100, 200; receiving an admission application at step 302; and storing data relating to aspects of the admission application, received in step 302, e.g., factors related to the admission application and other student application information, such as, but not limited to, agency location, transcript reliability, language proficiency score reliability, and application completeness, in a memory device (not shown) at step 303. This data is correlated with the data stored in the memory 303 when previous admission applications from the same agency were submitted through this multi-institutional admission application system.

Still referring to FIG. 3, the method 300 further comprises calculating an agency score in step 304 based on data relating to at least one factor stored in the memory device in step 303, from at least one admission application received in step 302. Calculating the agency score, in step 304, comprises at least one of: automatically calculating the agency score each time an admission application is submitted through the multi-institutional admission application system; manually calculating the agency score when a user directly, or indirectly, requests at least one of a recalculation and a report; and, if a fee is paid to the agencies, at least partially calculating this fee from the agency score. Calculating the agency score, in step 304, further comprises recalculating the agency score, thereby providing a recalculated score or a “new” score.

Still referring to FIG. 3, if an agency's score is recalculated in step 304, the method 300 further comprises taking an action on the recalculated score or new score or on a difference between a prior score and the new score, in step 305. Taking the action, in step 305, comprises at least one of: generating an output, the output comprising at least one of a notification and a report, preventing new applications from an agency, and allowing new applications from an agency. The method 300 further comprises sending the other to one or more users at step 306, the users comprising at one or more institutions or organizations. The method 300 further comprises displaying the output on a user interface at step 307. Displaying comprising one of using a push-type action and using a pull-type action, wherein the push-type action enables automatic recalculation, and wherein the pull-type action enables the report to be created upon request.

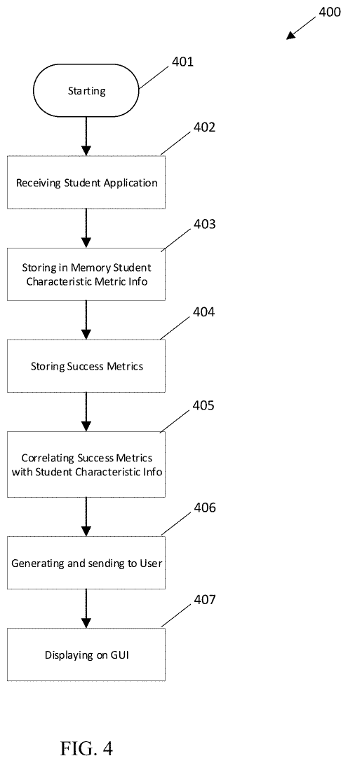

Referring to FIG. 4, this flow diagram illustrates a method 400 of optimizing data sharing by way of a multi-institutional admission application system, e.g., the systems, 100, 200, in accordance with an embodiment of the present disclosure. The method 400 comprises: starting at step 401, e.g., by initiating operation of the multi-institutional admission application system, e.g., the systems, 100, 200; receiving an admission application at step 402; and storing data relating to aspects of the admission application, received in step 402, e.g., factors related to the admission application and other student application information, such as, but not limited to, characteristic metric information, e.g., success metrics, a place of origin, language proficiency scores, a native language, previous work experience, work history, program and educational institution, at step 403.

Still referring to FIG. 4, the method 400 further comprises correlating the data, e.g., success metrics, stored at step 403, with data relating to student characteristics at step 405. When the user directly, or indirectly, requests a correlation report, the system correlates the success metrics with the characteristic metrics, with the relevant factors for each set of metrics specified by the user in step 405. As an admission application progresses through the method 400 by using the multi-institutional admission application system, e.g., the systems, 100, 200, and eventually terminates using the multi-institutional admission application system, student success metrics are received from educational institutions and stored by the multi-institutional admission application system and correlated to the characteristic metric information for the same student or admission applicant, the Student Success Metrics comprising factors, such as, but not limited to, grades, test performance, self-reported satisfaction with the program, status of graduation, or status of post-graduation employment in step 404.

Still referring to FIG. 4, the method 400 further comprises generating and sending output to the user at step 406. The output comprises at least one of a report and correlation information is generated and sent to one of more users who may be at one or more institutions or organizations. Correlating the data at step 405 comprises using mathematical functions that indicate similarity between at least one of different data or sets of data. Correlating the data at step 405 further comprises determining and expressing confidence intervals, such as a measure of confidence that the data sets are similar. The method 400 further comprises displaying the output on a user interface, e.g., a graphic user interface (GUI), at step 407.

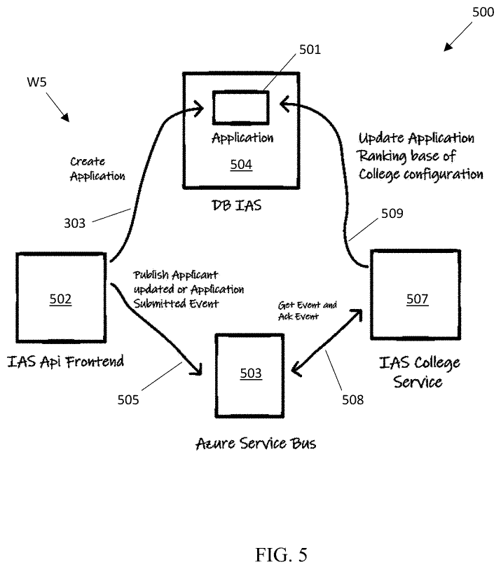

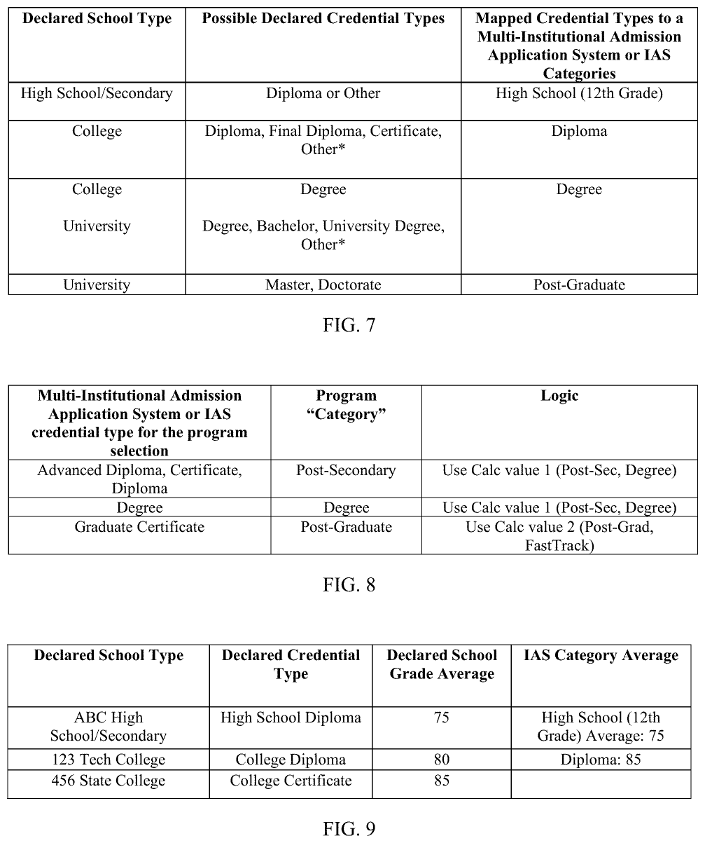

Referring to FIG. 5, this diagram illustrates workflow W5 in an implementation of a multi-institutional admission application system, e.g., the systems 100, 200, comprising a ranking subsystem 500, for optimizing data sharing by a plurality of institutions (not shown) in relation to a plurality of multi-institutional admission applications 501, in accordance with an embodiment of the present disclosure. The ranking subsystem 500 comprises: an application program interface front end 502 configured to communicate with at least one of a service bus 503 and a database 504. The application program interface front end 502 is further configured to at least one of: publish an event from at least one of an admission applicant update and an admission application submission, as indicated by arrow 505; and facilitate completion of an admission application, as indicated by arrow 506. The service bus 503 is configured to communicate with an institutional service module 507, such as a college service, e.g., an international application system college service. The service bus 503 is configured to receive the from at least one of an admission applicant update and an admission application submission, as indicated by arrow 505, and to transmit an acknowledgement of the event to the institutional service module 507, as indicated by arrow 508. The service bus 503 comprises a Microsoft® Azure® service bus, by example only. The institutional service module 507 is configured to communicate with the database 504. The institutional service module 507 is further configured to update ranking of an admission application 501, thereby providing an updated ranking, and to transmit the updated ranking to the database 504, as indicated by arrow 509. The ranking subsystem 500 further comprises at least one of the service bus 503, the database 504, and the institutional service module 507. In one embodiment, the primary use of the service bus is to queue requests for mapping, as discussed in conjunction with FIG. 7 below, wherein grades are mapped to a corresponding average field. In one embodiment, the ranking score is determined from at least one of the grade average, English language test score or another factor; where more than one factor is used, a weighting of factors is used to calculate the ranking score. In one embodiment, a machine learning or artificial intelligence or automated intelligence subsystem may be used to analyze the original transcript, capture the grades listed on the transcript, preferably capture other information on the transcript, and preferably calculate the average and weightings for factors, preferably without or with minimal manual data entry.

Still referring to FIG. 5, the ranking subsystem 500 is configured, by a set of executable instructions storable in relation to a non-transient memory device (not shown), to rank each multi-institutional admission application 501 of a plurality of multi-institutional admission applications 501 based on initial criteria of, the initial criteria comprising at least two of a grade average from at last one secondary school, a high school diploma, a grade average from at last one higher educational institution, a college degree, a university degree, a graduate degree, and a post-graduate credential, wherein the ranking subsystem 500 is configured to rank the initial criteria of each multi-institutional admission application 501 by one of: ranking the grade average of the at least one secondary school identified in each multi-institutional admission application for an undergraduate program; and ranking the grade average of the at last one higher educational institution identified in each multi-institutional admission application for one of a graduate program and a post-graduate program. The grade averages are provided by at least one of an agency and an admission applicant. Ranking grade averages is referred herein as “short-term” ranking.

Still referring to FIG. 5, the ranking subsystem 500 is further configured to rank each multi-institutional admission application 501 of the plurality of multi-institutional admission applications based on at least one customized criterion, wherein the at least one customized criterion is provided by at least one institution of a plurality of institutions, and wherein the at least one customized criterion is reconfigurable by at least one institution of a plurality of institutions. The at least one customized criterion comprises at least one of: at least one specific country name, at least one specific agency name, and at least one specified program name. The at least one customized criterion further comprises a language proficiency test score, e.g., an English language proficiency test score. For example, ranking of a multi-institutional admission application is strengthened if the multi-institutional admission application indicates a language proficiency test has been taken through a trusted partnership school or a trusted pathway school in relation to the at least one institution of the plurality of institutions.

Still referring to FIG. 5, the at least one customized criterion further comprises status data relating to a probability that an admission applicant of the admission application can remain in a given jurisdiction, e.g., via a student visa. For example, strength of a candidacy for a “study permit” or a “student visa” in the given jurisdiction using status data from the multi-institutional admission application relating to factors, such as whether a given admission applicant is already physically present in the given jurisdiction, a likelihood that such admission applicant can legally remain in the given jurisdiction after completing a given program, a relationship of such admission applicant's projected skills, if at all, to such jurisdiction's essential skills or desired skills, e.g., Canada's nine essential skills, and whether a given admission applicant has already obtained the requisite governmental permit or visa, and whether a given admission applicant has been denied the requisite governmental permit or visa in the past. The at least one customized criterion further comprises any other skill assessment data, such as skill assessment data relating to specific subjects, e.g., English, Mathematics, and Science, that are determined through testing by a given institution. The at least one customized criterion further comprises verifiable academic grade averages based on an admission applicant's declared previous education history. The at least one customized criterion further comprises data indicating whether an admission applicant is working with an agency and data indicating a previous success rate of such agency.

Still referring to FIG. 5, by further configuring the ranking subsystem 500 to rank each multi-institutional admission application of the plurality of multi-institutional admission applications based on the least one customized criterion, the admissions factors for each institution are optimized in ranking the admission applications. Also, the ranking subsystem 500 is further configured to generate and provide data relating to the rank of each multi-institutional admission application of the plurality of multi-institutional admission applications based on the least one customized criterion, thereby facilitating admissions offer assessment by admissions staff. Ranking each multi-institutional admission application of the plurality of multi-institutional admission applications based on the at least one customized criterion is referred herein as “medium-term” ranking.

Still referring to FIG. 5, the ranking subsystem 500 is further configured to automatically perform specific actions in relation to the lowest ranked admission applications. For example, the ranking subsystem 500 is further configured to automatically decline the lowest ranked 80% of the plurality of multi-institutional admission applications based on at least one customized criterion. However, admissions staff can still manually “audit” admission applications that were automatically evaluated to check whether an admissions staff member would have made the same decision and ensure the accuracy/efficacy of applying the at least one customized criterion. Ranking each multi-institutional admission application of the plurality of multi-institutional admission applications based on the at least one customized criterion is referred herein as “long-term” ranking.

Still referring to FIG. 5, the ranking subsystem 500 is further configured to be available in a college setting, e.g., enabled by Ontario College Application System Information Technology System (OCAS ITS) or equivalent. This will be configured only for specified countries, and this is based on the declared school country. For “GoLive” feature, this will be enabled only for schools from a certain jurisdiction, e.g., India.

This means when Agent/Applicant enters a school from any other country, they will not be prompted to provide Grade Averages, and the ranking calculations will not be available for any other countries other than the certain jurisdiction, e.g., India.

Still referring to FIG. 5, the application program interface front end 502 further comprises a GUI (not shown), in accordance with some embodiments of the present disclosure. The GUI comprises a stepper feature and is configured to receive information, via data entry into at least one fillable field, from at least one user, e.g., an admissions applicant and an agent. The information comprises information relating to at least one grade average. For example, the at least one grade average comprises a grade average, e.g., a grade point average, for each declared school of each admissions applicant that is declared on each admissions application. By examples only, for a secondary school or a high school, a grade average is taken of all grade 12 course grades for a college or any similar credential type of institution, a grade average is taken of all course grades through all attendance years; and for a university or any similar credential type of institution, a grade average is taken of all course grades through all attendance years. However, for an English language partnership school or pathway school, a grade average is not required, wherein the stepper feature forgoes displaying a field for entering a grade average.

Still referring to FIG. 5, the GUI is further configured to render an “Education Summary” webpage for displaying the information, received via the stepper feature, provided by the user, e.g., the admissions applicant and the agent. The GUI is further configured to render a “Review” webpage for facilitating review of the information, received via the stepper feature, provided by the user, e.g., the admissions applicant and the agent, before submitting the admission application. The GUI is further configured to render at least one of an “App Details” webpage and a “View Profile” webpage for displaying the information, received via the stepper feature, provided by the user, e.g., the admissions applicant and the agent.

Still referring to FIG. 5, the GUI is further configured to receive, e.g., via the stepper feature, updated information, e.g., after submitting the admissions application, provided by the user, e.g., the admissions applicant and the agent, in accordance with some embodiments of the present disclosure. Such further information comprises updated completion of education information, updated grade average information, and the like. The ranking subsystem 500 is further configured to update the information based on the updated information. For example, when the user provides a name of a new school after the admission application is submitted, or updates a completed education, the ranking subsystem 500 assumes that updated grade average information needs to be provided. The GUI is further configured to prompt the user for updated grade average information if the user has provided information regarding a recently completed education if the user has not already provided such updated grade average information. Optionally, the ranking subsystem 500 is configured to recalculate ranking values or scores based on the updated information.

Still referring to FIG. 5, the ranking subsystem 500 is further configured to rank the admission applications by using at least one assumption, in accordance with some embodiments of the present disclosure. The at least one assumption comprises at least one of: an assumption that all grade averages are based on a 0-100 scoring scale, wherein, if the user provides at least one of the information and the updated information comprising a grade average according to at least one of a grade point average (GPA) scale and a letter-based grading scale, the ranking calculation is not deemed useful for comparison with grade averages according to a 0-100 scoring scale; an assumption that a grade average value is required all the time, regardless of a completion status in relation to a given institution, wherein, if the user declares “in progress” for a given institution, the GUI is further configured to prompt the user for a grade average corresponding to the courses thus far completed; an assumption that particular information or particular updated information is collected and requires a grade average conversion only when a particular institution is located in a particular jurisdiction, e.g., India, having a distinct grading system than that of a given institution in a given jurisdiction, e.g., Canada, for which the admission application is submitted; an assumption that a grade average being submitted is in a format that is compatible with the fillable field type, e.g., numeric and without decimals; an assumption that the user is responsible for obtaining and providing the final grade average values and information; and an assumption that a calculated average is not required for English language partnership school or pathway school,

Still referring to FIG. 5, the GUI is further configured to render a “College View” webpage, having an “Education” card, for displaying information relating to at least one grade average that is declared by the user. On the “College View” webpage, the declared average for each institution is rendered on the “Education” card under a display of school details to facilitate viewing by the user, e.g., an admissions staff member. The GUI is further configured to render an “Academic Averages” webpage for facilitating ranking the admission applications. For example, “Academic Averages” webpage displays the highest grade averages, by credential type, from all declared institution, e.g., for a high school or a secondary school up to grade 12^{th}, the highest grade average of 83 is displayed as being from a declared institution, for a diploma, the highest grade average of 80 is displayed as being from a declared institution, for a college, university, or undergraduate degree, the highest grade average of 75 is displayed as being from a declared institution, and for a graduate or a post-graduate degree, the highest grade average of 85 is displayed as being from a declared institution. However, if no information is available in relation to a declared institution, e.g., its credentials, no data will be displayed via the GUI.

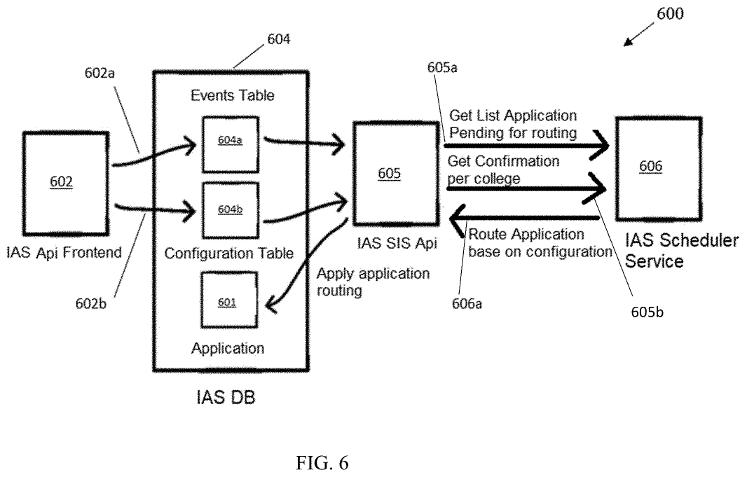

Referring to FIG. 6, this diagram illustrates workflow W6 in an implementation of a multi-institutional admission application system, e.g., the systems 100, 200, comprising a routing subsystem 600, for optimizing data sharing by a plurality of institutions (not shown) in relation to a plurality of multi-institutional admission applications 601, in accordance with an embodiment of the present disclosure. The routing subsystem 600 comprises: an application program interface front end 602 configured to communicate with a database 604. The application program interface front end 602 is further configured to transmit at least one of event information, as indicated by arrow 602a, and configuration information, as indicated by arrow 602b, to the database 604. The database 604 is configured to receive and respectively store at least one of the event information and the configuration information in an event table 604a, and a configuration table 604b. The database 604 is further configured to communicate with a Student Information System (SIS) application program interface 605, an SIS being an application system where an educational institution maintains student records, e.g. grades, courses taken, previous education. The database 604 is further configured to receive and store the plurality of multi-institutional admission applications 601. The database 604 is further configured to transmit data relating to the event table 604a, as indicated by arrow 604c, and data relating to the configuration table 604b, as indicated by arrow 604d, to the SIS application program interface 605. The SIS application program interface 605 is configured to communicate with a scheduler service module 606. The SIS application program interface 605 is further configured to transmit data relating to at least one of: a list of admission applications, as indicated by arrow 605a, and a configuration per institution, as indicated by arrow 605b. The scheduler service module 606 is configured to receive data relating to at least one of: a list of admission applications, as indicated by arrow 605a, and a configuration per institution, as indicated by arrow 605b. The scheduler service module 606 is further configured to transmit and route at least one admissions application based on the data relating to the configuration per institution, as indicated by arrow 606a. The routing subsystem 600 further comprises at least one of the database 604, the SIS application program interface 605, and the scheduler service module 606.

Referring to FIG. 7, this table illustrates examples of declared school types, possible declared credential type, and a mapped credential type to a multi-institutional admission application system or international application system (IAS) categories as by the ranking subsystem 500 (FIG. 5), in accordance with an embodiment of the present disclosure. The ranking subsystem 500 is further configured to rank the admissions application by calculating values from declared grade average values, in accordance with some embodiments of the present disclosure. The ranking subsystem 500 is further configured to: calculate grade average values and to group the calculated grade average values by a declared credential type, calculate one grade average value for each of declared credential type of an admission application, wherein at least one of information having the same credential type from a plurality of institutions and information in the same credential category, e.g., a certificate in automotive technology, from a plurality of certifications, such as a junior college education, a high school diploma, and a trade certificate, is transformed as data compatible for use in a multi-institutional admission application system, e.g., the systems, 100, 200.

Still referring to FIG. 7, notably, in a majority of admission applications, admission applicants will have just one or two grade average values, depending on their current level of education, such as high school+university, or only high school. The ranking subsystem 500 is further configured to calculate grade average value for each of the following educational levels: a high school 12^{th} grade level, a high school diploma level, an undergraduate degree level, a graduate degree level, and a post-graduate level, wherein, if the admission applicant provides more than one grade average of the same type, the ranking subsystem 500 uses the highest grade average value of all the educational levels for advising the institutions.

Referring to FIG. 8, this table illustrates examples of multi-institutional admission application system or IAS credential types for the program selection, program categories, and logic as used by the ranking subsystem 500 (FIG. 5), in accordance with an embodiment of the present disclosure. The ranking subsystem 500 is further configured to calculate an overall grade average used for ranking an admission application. For example, the ranking subsystem 500 assumes that, when an IE team is ranking admission applications, the IE team would perform a manual ranking by program selection or a manual ranking by the credential type of the program selection. As such, the ranking subsystem 500 is further configured to rank the admission applications to a (for example) tourism diploma program, wherein, when doing so, the IE team should consider the credential type for that program, e.g., a diploma. The ranking subsystem 500 is further configured to determine which calculated average grade value should be used upon receiving feedback from the IE team via the GUI.

Still referring to FIG. 8, the ranking subsystem 500 is further configured to calculate two values, based on the categorized grade averages, wherein these two values are displayed via the GUI for use by the IE team in consideration of an admission applicant for an appropriate program. Such two values comprise: (i) a calculated grade average value for at least one of a post-secondary school program and an undergraduate degree program, whereby the multi-institutional admission application system or the IAS takes the highest calculated grade average value among an average grade value for high school, an average grade value for a secondary school diploma, and an average grade value for an undergraduate degree; and (ii) a calculated grade average value for at least one of a post-graduate program and a fast-track program, whereby the multi-institutional admission application system or the IAS takes the highest calculated grade average value between an average grade value for an undergraduate degree and an average grade value for at least one of a post-graduate program and a fast-track program. The ranking subsystem 500 is further configured to calculate these values from (i) and (ii), in addition to other average values calculated by the ranking subsystem 500, based on the logic, as shown in FIG. 8, whereby at least these values from (i) and (ii) are displayable, via the GUI, to the IE team for further use. For example, if screening for a program choice (or program recommendation) where the credential type=Graduate Certificate or any “Fast-track” program, then IE Team will use “Calc Avg 1;” and, if screening for a program choice (or program recommendation) where the credential type=Graduate Certificate or any “Fast-track” program, then IE Team will use “Calc Avg 2.”

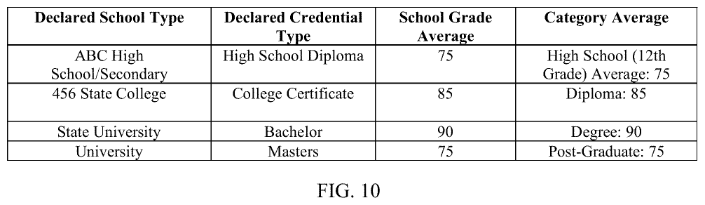

Referring to FIGS. 9 and 10, together, these tables illustrate examples of a declared school type, a declared credential type, a declared school grade average and multi-institutional admission application system or IAS category average, as used by the ranking subsystem 500 (FIG. 5), in accordance with an embodiment of the present disclosure. The ranking subsystem 500 is further configured to map an appropriate credential type, such as one equal or equivalent to a Diploma for a college or Degree for a University, in relation to an “Other” option. The ranking subsystem 500 is further configured to calculate ranking by using at least one assumption, wherein, if the admission applicant has provided multiples of the same credential type, the multi-institutional admission application system or the IAS will use the highest value for the calculation, and wherein, the credential classifications are multi-institutional admission application system-wide or IAS-system wide, e.g., not necessarily specific to any IAS.

Still referring to FIGS. 9 and 10, together, the ranking subsystem 500 is further configured to at least one of rank and sort admission applications in relation to an undergraduate program; and the ranked and sorted admission applications are rendered on a “My Lists” webpage, wherein a user views a list of ranked and sorted admission applications with their respective grade averages and summaries thereof, and whereby an IE team can further rank and sort admission applications by using the declared averages and calculated averages. The ranking subsystem 500 is further configured to at least one of receive and capture information relating to at least one data element of: a high school grade average, a secondary school diploma grade average, an undergraduate degree program grade average, a graduate degree program grade average, a graduate certificate program grade average, a post-graduate degree program grade average, and a fast-track certificate program grade average. The ranking subsystem 500 is further configured to at least one of process and transform at least one data element, thereby respectively providing processed data and transformed data. The ranking subsystem 500 is further configured to display new information relating to at least one of the processed data and the transformed data, e.g., in new fields on the “My Lists” webpage. Here, transformation refers to the calculation of a single ranking from one or more factors. In one embodiment, the transformation may be a mapping between High School and Post-Secondary Degree, or Degree to Post-Graduate. If the applicant reports multiple education experiences each with an average, in one embodiment the calculation may be to average the individual scores. In one embodiment, the transformation calculation may use multiple factors, e.g. grades, agency ranking, English proficiency score, to produce a single ranking.

Still referring to FIGS. 9 and 10, together, the ranking subsystem 500 is further configured to assume that, for ranking admission applications for diploma programs or degree programs, at least one of a high school grade average, a secondary school diploma grade average, an undergraduate degree program grade average, a graduate degree program grade average, a post-graduate degree program grade average are relevant for so ranking. The ranking subsystem 500 is further configured to assume that, for ranking admission applications for fast-track certificate programs or graduate certificate programs, at least one of an undergraduate degree program grade average, a graduate degree program grade average, a fast-track certificate program grade average and a graduate certificate program grade average are relevant for so ranking. The ranking subsystem 500 is further configured to at least one of create and save a plurality of lists via the “My Lists” webpage through the GUI. The ranking subsystem 500 is further configured to update the plurality of lists and to render updated information lists via the “My Lists” webpage through the GUI, e.g., by refreshing the “My Lists” webpage.

Referring to FIG. 9, this table illustrates example parameters for screening by the ranking subsystem 500 for post-secondary school degree program, in accordance with an embodiment of the present disclosure. For example, the IE team is considering an admission applicant for a certificate program in tourism, e.g., hotel management, hospitality management, travel agency, etc., using the parameters “Tourism (1824)” and a credential type=“Diploma;” and the admission applicant's declared grade averages and categorizations are as illustrated in the table of FIG. 9. The ranking subsystem 500 is further configured to at least one of: calculate a grade average value for a post-secondary school degree program by taking the highest grade average value, e.g., 85, among a high school grade average value, a secondary school diploma grade average value, and an undergraduate degree program grade average value; and determine that grade average value is not applicable for at least one of a fast-track certificate program and a graduate certificate program by assigning a textual designation, e.g., “not applicable” or “N/A.” The ranking subsystem 500 is further configured to display information relating to at least one of the calculated data value and the textual designation, e.g., “Calc Avg 1 (Post-Sec/Degree),” and optionally “High School Average” and “Diploma Average,” via the “My Lists” webpage through the GUI, whereby the IE team are able to use such information.

Referring to FIG. 10, this table illustrates example parameters for screening by the ranking subsystem 500 for project management program, in accordance with an embodiment of the present disclosure. For example, the IE team is considering an admission applicant for a project management program, using the parameters “Project Management (2528)” and a credential type=“Graduate Certificate (Post-Grad),” as illustrated in the table of FIG. 10. The ranking subsystem 500 is further configured to at least one of: calculate a grade average value for a post-secondary school degree program by taking the highest grade average value, e.g., 90, among a high school grade average value, a secondary school Diploma grade average value, and an undergraduate degree program grade average value; and calculate a grade average value for a post-secondary school degree program by taking the highest grade average value, e.g., 90, among a fast-track certificate program and a graduate certificate program. The ranking subsystem 500 is further configured to display information relating to at least one of the calculated data value and the textual designation, e.g., “Calc Avg for (Post Grad),” and optionally “Degree Average” and “Post Grad Average,” via the “My Lists” webpage through the GUI, whereby the IE team are able to use such information.

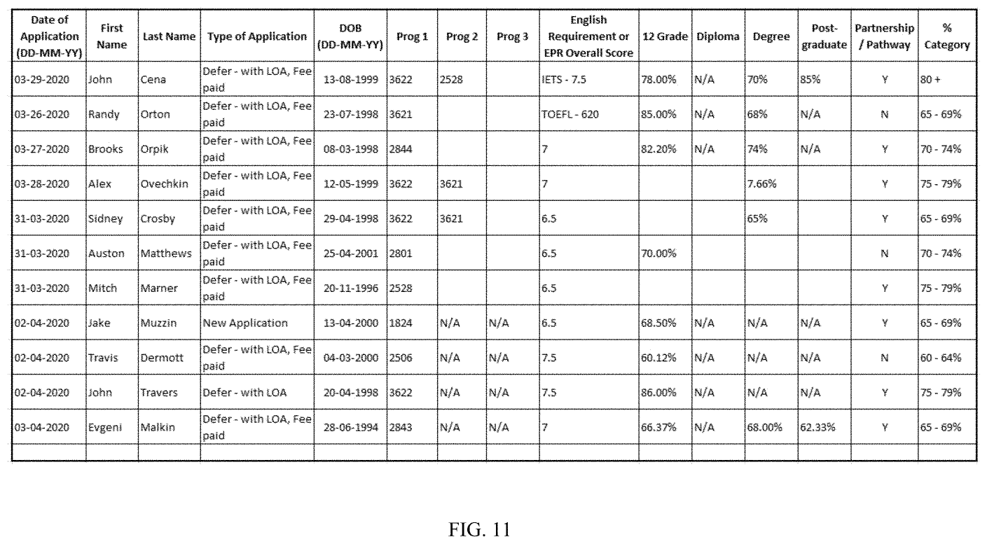

Referring to FIG. 11, this table illustrates example parameters for screening by the ranking subsystem 500 for a fast-track program, in accordance with an embodiment of the present disclosure. For example, the IE team is considering an admission applicant for an advanced biotechnology fast-track program, using the parameters “Biotechnology Advanced Fast Track (3622)” and a credential type=“Diploma,” as illustrated in the table of FIG. 11. The ranking subsystem 500 is further configured to display information relating to at least one of the calculated data value and the textual designation, e.g., “Calc Avg for (Post Grad and Fast Track),” and optionally “Degree Average” and “Post Grad Average,” via the “My Lists” webpage through the GUI, whereby the IE team are able to use such information (if it's not possible to calculate one of these values, due to unavailable declared school types, then nothing will appear).

Still referring to FIG. 11, the ranking subsystem 500 is further configured to make at least one assumption of: that a grade average is saved as an attribute of a declared school and is based on an admission applicant's profile; that, if the admission applicant applies to other institutions of the IAS, the grade average is visible to other institutions of the IAS, e.g., in the same manner that other school details and transcript documents are managed; that the categorized values are also saved on the admission applicant profile; that the calculated values are specific to an institution's business logic; and that the calculated values will not be visible to institutions, agents, or admission applicants that are outside the IAS; that the IAS will not verify grade average information entered by the agent/applicant; that a user can adjust grade values, use a “needs more information flow” feature, or contact the agent/applicant (outside of IAS) to advise whether the mistake needs correction; that the values are calculated either at submit time or as part of a scheduled job, to avoid taxing the system on submits; and that the IE team can use the “My Lists” webpage to search and setup a list of programs that have “Fast Track” in the title (selected individually) in order to manage such programs.

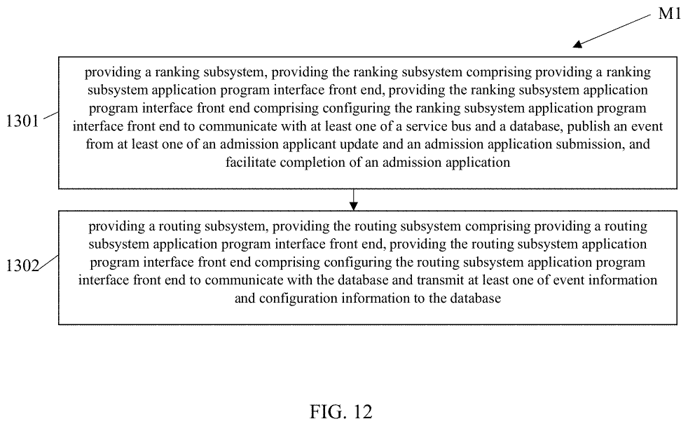

Referring to FIG. 12, this flow diagram illustrates a method M1 of providing an admission application system, having a processor configurable by a set of executable instructions storable in relation to a non-transient memory device, for optimizing data sharing in relation to a plurality of admission applications, in accordance with an embodiment of the present disclosure. The method M1 comprises: providing a ranking subsystem, providing the ranking subsystem comprising providing a ranking subsystem application program interface front end, providing the ranking subsystem application program interface front end comprising configuring the ranking subsystem application program interface front end to communicate with at least one of a service bus and a database, publish an event from at least one of an admission applicant update and an admission application submission, and facilitate completion of an admission application, as indicted by block 1301; and providing a routing subsystem, providing the routing subsystem comprising providing a routing subsystem application program interface front end, providing the routing subsystem application program interface front end comprising configuring the routing subsystem application program interface front end to communicate with the database and transmit at least one of event information and configuration information to the database, as indicted by block 1302.

Still referring to FIG. 12, in the method M1, in providing the ranking subsystem, at least one of: the service bus is configured to communicate with an institutional service module; the service bus is further configured to: receive data relating to at least one of the admission applicant update and the admission application submission, and transmit an acknowledgement of the event to the institutional service module; and the institutional service module is configured to: communicate with the database; update ranking of an admission application, thereby providing an updated ranking, and transmit the updated ranking to the database. Providing the ranking subsystem further comprises providing at least one of the service bus, the database, and the institutional service module. In providing the ranking subsystem, at least one of: the database is configured to: receive data relating to at least one of event information and configuration information; store data relating to at least one of the event information in an event table and the configuration information in a configuration table; communicate with an SIS application program interface; transmit data relating to the event table and data relating to the configuration table to the SIS application program interface; receive the plurality of admission applications; and store the plurality of multi-institutional admission applications.

Still referring to FIG. 12, in the method M1, in providing the routing subsystem, at least one of: the SIS application program interface is configured to: communicate with a scheduler service module; and transmit data relating to at least one of a list of admission applications and a configuration per institution; and the scheduler service module is configured to: receive data relating to at least one of the list of admission applications and the configuration per institution; and transmit and route at least one admission application of the plurality of admission applications based on the data relating to at least one of the list of admission applications and the configuration per institution. Providing the routing subsystem further comprises providing at least one of the SIS application program interface and the scheduler service module.

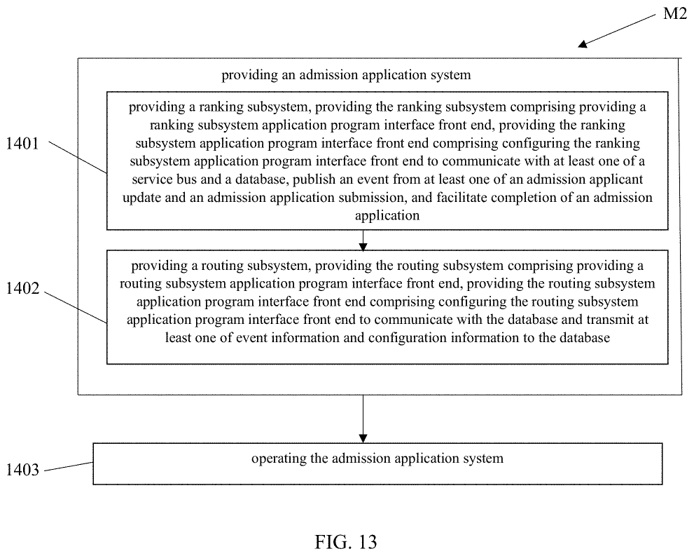

Referring to FIG. 13, this flow diagram illustrates a method M2 of optimizing data sharing in relation to a plurality of admission applications by way of an admission application system, having a processor configurable by a set of executable instructions storable in relation to a non-transient memory device, in accordance with an embodiment of the present disclosure. The method M2 comprises: providing the admission application system, as indicated by block 1400, providing the admission application system comprising: providing a ranking subsystem, providing the ranking subsystem comprising providing a ranking subsystem application program interface front end, providing the ranking subsystem application program interface front end comprising configuring the ranking subsystem application program interface front end to communicate with at least one of a service bus and a database, publish an event from at least one of an admission applicant update and an admission application submission, and facilitate completion of an admission application, as indicated by block 1401; and providing a routing subsystem, providing the routing subsystem comprising providing a routing subsystem application program interface front end, providing the routing subsystem application program interface front end comprising configuring the routing subsystem application program interface front end to communicate with the database and transmit at least one of event information and configuration information to the database, as indicated by block 1402; and operating the admission application system, as indicated by block 1403.

While various embodiments have been described above, understood is that the various embodiments have been presented by way of example only, and not limitation. Where schematics and/or embodiments described above indicate certain components arranged in certain orientations or positions, the arrangement of components may be modified. While the embodiments have been particularly shown and described, it will be understood that various changes in form and details may be made.

Although various embodiments have been described as having particular features, concepts, and/or combinations of components, other embodiments are possible having any combination or sub-combination of any features, concepts, and/or components from any of the embodiments described herein. The specific configurations of the various components can also be varied. For example, the specific size, specific shape, and/or specific configuration of the various components and/or various inputs or outputs can be different from the embodiments shown, while still providing the functions as described herein. The size, shape, and/or configuration of the various components can be specifically selected for a desired or intended usage.

Where methods and/or events described above indicate certain events and/or procedures occurring in certain order, the ordering of certain events and/or procedures may be modified and that such modifications are in accordance with accepted and/or desired variations of the specific embodiments. Additionally, certain events and/or procedures may be performed concurrently in a parallel process when possible, as well as performed sequentially as described above. Certain steps may be partially completed or may be omitted before proceeding to subsequent steps.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments; and the claims are not limited by anything other than their subject matter, wherein any reference to an element being made in the singular is not intended to denote “one and only one” unless explicitly so stated, but, rather to denote “at least one” or “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public, regardless of whether the element, component, or method step is explicitly recited in the claims. However, various changes and modifications in form, material, work-piece, and fabrication material detail may be made, without departing from the spirit and scope of the present disclosure, as set forth in the appended claims, are also encompassed by the present disclosure. In addition, any combination or permutation of any feature, as herein explicitly and/or implicitly disclosed, is also encompassed by the present disclosure.

What is claimed:

1. An admission application system, having a processor configurable by a set of executable instructions storable in relation to a non-transient memory device, for optimizing data sharing in relation to a plurality of admission applications, the system comprising:
a ranking subsystem, the ranking subsystem comprising a ranking subsystem application program interface front end, the ranking subsystem application program interface front end configured to communicate with at least one of a service bus and a database, publish an event from at least one of an admission applicant update and an admission application submission, and facilitate completion of an admission application; and
a routing subsystem, the routing subsystem comprising a routing subsystem application program interface front end, the routing subsystem application program interface front end configured to communicate with the database and transmit at least one of event information and configuration information to the database.

2. The system of claim 1, wherein the service bus is configured to communicate with an institutional service module.

3. The system of claim 2, wherein the service bus is further configured to: receive data relating to at least one of the admission applicant update and the admission application submission, and transmit an acknowledgement of the event to the institutional service module.

4. The system of claim 2, wherein the institutional service module is configured to: communicate with the database; update ranking of an admission application, thereby providing an updated ranking, and transmit the updated ranking to the database.

5. The system of claim 2, wherein the ranking subsystem further comprises at least one of the service bus, the database, and the institutional service module.

6. The system of claim 1, wherein the database is configured to: receive data relating to at least one of event information and configuration information; store data relating to at least one of the event information in an event table and the configuration information in a configuration table; communicate with an SIS application program interface; and transmit data relating to the event table and data relating to the configuration table to the SIS application program interface.

7. The system of claim 1, wherein the database is configured to: receive the plurality of admission applications; store the plurality of multi-institutional admission applications.

8. The system of claim 6, wherein the SIS application program interface is configured to: communicate with a scheduler service module; and transmit data relating to at least one of a list of admission applications and a configuration per institution.

9. The system of claim 8, wherein the scheduler service module is configured to: receive data relating to at least one of the list of admission applications and the configuration per institution; and transmit and route at least one admission application of the plurality of admission applications based on the data relating to at least one of the list of admission applications and the configuration per institution.

10. The system of claim 8, wherein the routing subsystem further comprises at least one of the database, the SIS application program interface, and the scheduler service module.

11. A method of providing an admission application system, having a processor configurable by a set of executable instructions storable in relation to a non-transient memory device, for optimizing data sharing in relation to a plurality of admission applications, the method comprising:
providing a ranking subsystem, providing the ranking subsystem comprising providing a ranking subsystem application program interface front end, providing the ranking subsystem application program interface front end comprising configuring the ranking subsystem application program interface front end to communicate with at least one of a service bus and a database, publish an event from at least one of an admission applicant update and an admission application submission, and facilitate completion of an admission application; and
providing a routing subsystem, providing the routing subsystem comprising providing a routing subsystem application program interface front end, providing the routing subsystem application program interface front end comprising configuring the routing subsystem application program interface front end to communicate with the database and transmit at least one of event information and configuration information to the database.

12. The method of claim 11, wherein providing the ranking subsystem, the service bus is configured to communicate with an institutional service module.

13. The method of claim 12, wherein providing the ranking subsystem, the service bus is further configured to: receive data relating to at least one of the admission applicant update and the admission application submission, and transmit an acknowledgement of the event to the institutional service module.

14. The method of claim 12, wherein providing the ranking subsystem, the institutional service module is configured to: communicate with the database; update ranking of an admission application, thereby providing an updated ranking, and transmit the updated ranking to the database.

15. The method of claim 12, wherein providing the ranking subsystem further comprises providing at least one of the service bus, the database, and the institutional service module.

16. The method of claim 11, wherein providing the ranking subsystem, the database is configured to: receive data relating to at least one of event information and configuration information; store data relating to at least one of the event information in an event table and the configuration information in a configuration table; communicate with an SIS application program interface; transmit data relating to the event table and data relating to the configuration table to the SIS application program interface; receive the plurality of admission applications; and store the plurality of multi-institutional admission applications.

17. The method of claim 16, wherein providing the routing subsystem, the SIS application program interface is configured to: communicate with a scheduler service module; and transmit data relating to at least one of a list of admission applications and a configuration per institution.

18. The method of claim 17, wherein providing the routing subsystem, the scheduler service module is configured to: receive data relating to at least one of the list of admission applications and the configuration per institution; and transmit and route at least one admission application of the plurality of admission applications based on the data relating to at least one of the list of admission applications and the configuration per institution.

19. The method of claim 18, wherein providing the routing subsystem further comprises providing at least one of the SIS application program interface and the scheduler service module.

20. A method of optimizing data sharing in relation to a plurality of admission applications by way of an admission application system, having a processor configurable by a set of executable instructions storable in relation to a non-transient memory device, the method comprising:
providing the admission application system, providing the admission application system comprising:
providing a ranking subsystem, providing the ranking subsystem comprising providing a ranking subsystem application program interface front end, providing the ranking subsystem application program interface front end comprising configuring the ranking subsystem application program interface front end to communicate with at least one of a service bus and a database, publish an event from at least one of an admission applicant update and an admission application submission, and facilitate completion of an admission application; and
providing a routing subsystem, providing the routing subsystem comprising providing a routing subsystem application program interface front end, providing the routing subsystem application program interface front end comprising configuring the routing subsystem application program interface front end to communicate with the database and transmit at least one of event information and configuration information to the database; and
operating the admission application system.
